(19) United States
(12) Patent Application Publication
(10) Pub. No.: US 2009/0106145 A1
(43) Pub. Date: Apr. 23, 2009

(54) APPEAL MECHANISM FOR A CONTRACT DISPUTE IN A VIRTUAL WORLD

(76) Inventors: Brian R. Bokor, Raleigh, NC (US); Daniel E. House, Raleigh, NC (US); Andrew B. Smith, Morrisville, NC (US); William B. Nicol, II, Durham, NC (US)

Correspondence Address: MOORE & VAN ALLEN, PLLC For IBM, P.O. Box 13706, Research Triangle Park, NC, 27709, US

(21) Appl. No.: 11/876,845

(22) Filed: Oct. 23, 2007

(51) Int. Cl. G06Q 10/00; G06Q 30/00

(52) U.S. Cl. 705/39; 705/1

(57) ABSTRACT

A method for appealing a decision in a contract dispute in a virtual world may include receiving a rejection of the decision in the contract dispute in the virtual world from at least one of a contractor and a contractee. The decision in the contract dispute may be made by a single arbitrator. The method may also include providing a mechanism to appeal the decision by the single arbitrator in the contract dispute in response to receiving the rejection from at least one of the contractor and the contractee.

### BACKGROUND OF THE INVENTION

The present invention relates to simulations, virtual world simulations of the real-world or real-life or a virtual world and the like, and more particularly to an appeal mechanism for a contract dispute in a virtual world.

Computer based simulations are becoming more ubiquitous. Simulations may be used for training purposes, for entertainment, for commerce or for other purposes. Computer simulations such as Second Life or similar simulations present a virtual world which allows users or players to be represented by characters known as avatars. Second Life is an Internet-based virtual world launched in 2003 by Linden Research, Inc. A downloadable client program called the Second Life Viewer enables users, called “Residents”, to interact with others in the virtual world through motional avatars. The virtual world basically simulates the real world or environment. The users or residents via their avatar can explore the virtual world, meet other users or residents, socialize, participate in individual and group activities, create and trade items (virtual property) and services from one another. The challenge with respect to such simulations or virtual worlds is to make them as realistic or as much like the real-world or real-life as possible. This increases the utility of such simulations as a training tool or enjoyment of the participants or users as an entertainment medium. Second Life is a trademark of Linden Research, Inc. in the United States, other countries or both.

### BRIEF SUMMARY OF THE INVENTION

In accordance with an embodiment of the present invention, a method for appealing a decision in a contract dispute in a virtual world may include receiving a rejection of the decision in the contract dispute in the virtual world from at least one of a contractor and a contractee. The decision in the contract dispute may be made by a single arbitrator (itself a virtual world participant, avatar, or resident). The method may also include providing a mechanism to appeal the decision by the single arbitrator in the contract dispute in response to receiving the rejection from at least one of the contractor and the contractee.

In accordance with another embodiment of the present invention, a method for appealing a decision in a contract dispute in a virtual world may include presenting the decision in the contract dispute to a contractor and a contractee and permitting the contractor and the contractee to accept or reject the decision in the contract dispute. The method may also include presenting a graphical user interface to appeal the decision in the contract dispute. The method may also include assigning a panel of arbitrators (i.e., avatars) to review the appeal and presenting information related to the contract dispute to each of the arbitrators to permit each of the arbitrators to review the contract dispute and to determine a resolution. The method may further include presenting a decision in the appeal of the contract dispute to the contractor and the contractee.

In accordance with another embodiment of the present invention, a method for a appealing a decision in a contract dispute in a virtual world may include presenting the decision in the contract dispute in the virtual world to a contractor and a contractee (again both avatars or otherwise virtual world inhabitants). The method may also include receiving a rejection of the decision in the contract dispute in the virtual world by at least one of the contractor and the contractee and providing a mechanism to appeal the decision in the contract dispute in response to receiving the rejection from at least one of the contractor and the contractee. The method may also include assigning a panel of arbitrators to review the appeal. Information related to the contract dispute may be presented to each of the arbitrators to permit each of the arbitrators to review the contract dispute and to determine a resolution. A plurality of possible resolutions of the contract dispute may be presented for each arbitrator to select. A final decision in the contract dispute will correspond to any one of the plurality of possible resolutions being selected by a majority of the panel of arbitrators. The method may further include presenting the final decision to the contract dispute to the contractor and the contractee.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block schematic diagram of an example of a system for contract formation, dispute resolution, and appealing a decision in a contract dispute in a virtual world in accordance with an embodiment of the present invention.

FIGS. 2A and 2B (collectively FIG. 2) are a flow chart of an example of a method for appealing a decision in a contract dispute in a virtual world in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

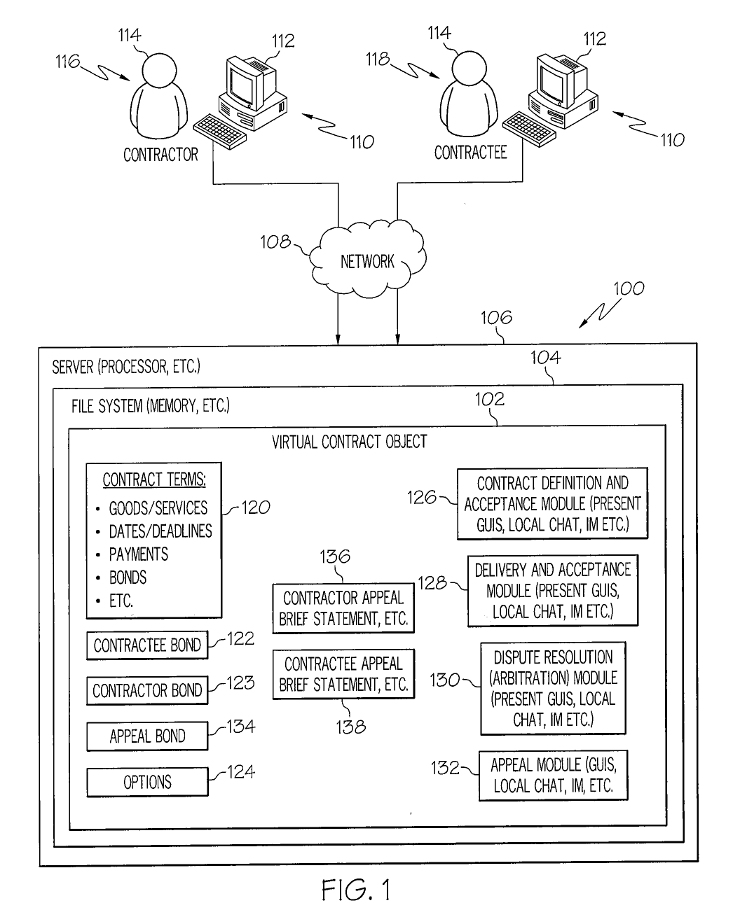

FIG. 1 is a block schematic diagram of an example of a system 100 for contract formation, contract dispute resolution, and appealing a decision in a contract dispute in a virtual world in accordance with an embodiment of the present invention. The system 100 may include a virtual contract object 102. The virtual contract object 102 may present one or more predetermined graphical user interfaces to permit formation of a contract for virtual goods or services in a virtual world or simulation and to permit settlement of any disputes that may arise related to the contract. As a feature of settlement of any contract disputes, the virtual contract object 102 may also present one or more predetermined graphical user interfaces to permit appeal of a decision in a contract dispute in the virtual world that is rejected by one or both parties to the contract. The virtual contract object 102 may be part of or a feature of a virtual world simulation system or program, such as Second Life or similar virtual world.

The virtual contact object 102 may also be a self contained system with embedded logic, decision making, state based operations and other functions that may operate in conjunction with a virtual world simulation, such as Second Life. The self contained system may allow businesses and individuals in the virtual world to operate across borders and legal systems. Virtual Worlds allow for legal or jurisdictional boundaries to be crossed much more easily. One embodiment of the present invention provides a system for working across legal or jurisdictional boundaries, cultural boundaries or the like, and dealing with any Government or legal issues that might be encountered in the real-world and can be created or simulated in the virtual world contract. For instance, someone in the United States building some virtual items, goods or objects for someone in China. An embodiment of the invention can provide a lightweight programmatic solution that can deal with formation of contacts dealing with any legal or Government entities, any legal boundary issues, international issues or similar issues.

The virtual contract object 102 may be stored on a file system 104 or memory of a server 106. The virtual contract object 102 may be accessed by users or participants via a network 108 using an Internet browser on a personal computer 110 or by similar means. The network 108 may be the Internet, a private network or other network. The predetermined GUIs that may be generated by the virtual contract object 102 as described herein and may be presented on a display 112 of the personal computer 110 to a user 114. As described herein, a user 114 who defines a contract for virtual goods or services may be defined as a contractor 116 and a user 114 that accepts the contract for the virtual goods and services may be defined as a contractee 118. The contractor 116 and contractee 118 are represented as avatars, residents or otherwise inhabitants of the virtual world.

The virtual contract object 102 may include contract terms 120. The contract terms 120 may be defined by the contractor 116. Examples of the contract terms may include an identification or description of the virtual goods or services to be offered; dates and deadlines, such as when the virtual goods or services will be offered, deadline for completion of the services, etc.; payments or costs for the goods or services; amount of a bond 122 that must be applied or stored in the virtual contract object 102 for payment by the contractee 118 upon fulfillment of the contract and acceptance by the contractee 118; and any other terms that may be pertinent to a particular virtual transaction or contract. In at least one embodiment of the present invention, the bond 122 may be referred to as a contractee bond paid by the contractee.

In another embodiment of the present invention, depending on the contract terms agreed to by the contractor 116 and contractee 118, the contractor 116 may also be required to apply a bond amount 123 to be included in the virtual contract object 102. This optional contractor bond 123 could be dispersed later in an arbitration process, or automatically returned to the contractor 116 upon successful completion of the virtual contact. Returning bond amounts 122 or 123, whether from contractor or contractee, upon successful completion of a contract is a functional feature of the virtual contract object 102.

The virtual contract object 102 may also include an options feature 124. The options feature 124 may include any future enhancements, configurations, and extensions to the existing system or any additions relating to the virtual contract object 102. As an example a notification system could be added to the virtual contract object 102 which could be configured as an option to email updates or provide notification by some other mechanism.

The virtual contract object 102 may also include a contract definition and acceptance module 126. An example of a method that may be embodied in the contract definition and acceptance module 126 is described in U.S. patent application Ser. No. 11/861,837, filed Sep. 9, 2007, entitled “Contract Formation and Dispute Resolution in a Virtual World, assigned to the same assignee as the present invention and incorporated herein in its entirety by reference. The contract definition and acceptance module 126 may present one or more GUIs to the contractor to permit the contractor to define the contract terms 120. Internet communications technologies or applications, such as Local Chat, Instant Messaging, e-mail, or similar communications means, may be used to permit defining the contract, negotiation of the contract between the contractor 116 and the contractee 118, and acceptance of the contract by the contractee 118.

The virtual contract object 102 may also include a delivery and acceptance module 128. The delivery and acceptance module 128 may permit the contractor 116 to designate that the contract terms have been fulfilled. The delivery and acceptance module 128 may also permit the contractee 118 to review any virtual deliverables or fulfillment of the contract terms and to accept the contract as being fulfilled or completed. The delivery and acceptance module 128 may present one or more GUIs for the contractor 116 to designate that the contract terms have been fulfilled and to permit review and acceptance by the contractee 118. Internet communications means similar to those previously described may also be utilized by the delivery and acceptance module 128 to permit communications between the contractor 116 and the contractee 118. An example of a method that may be embodied in the delivery and acceptance module 128 is also described in U.S. patent application Ser. No. 11/861,837 which is incorporated herein by reference.

The virtual contract object 102 may further include a dispute resolution or arbitration module 130. The dispute resolution module 130 provides a mechanism for resolution of any contract disputes between the contractor 116 and contractee 118. For example, in response to the contractee 118 not accepting that the contract has been fulfilled or completed, the contract may be designated or flagged as being in dispute. An arbitrator or panel of arbitrators may review the contract dispute and select an appropriate resolution. The dispute resolution module 130 may present appropriate GUIs to the contractor 116, contractee 118 and arbitrator in addition to utilization of other known Internet communications technologies to facilitate the resolution of any dispute. An example of a method that may be embodied in the dispute resolution module 130 is also described in U.S. patent application Ser. No. 11/861,837 which is incorporated herein by reference.

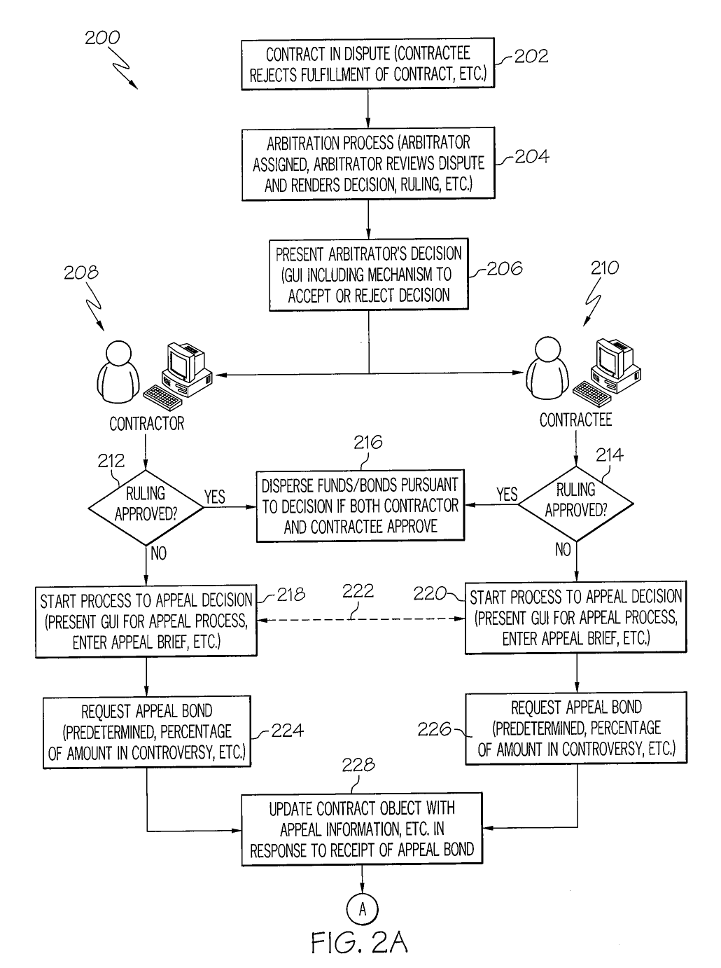

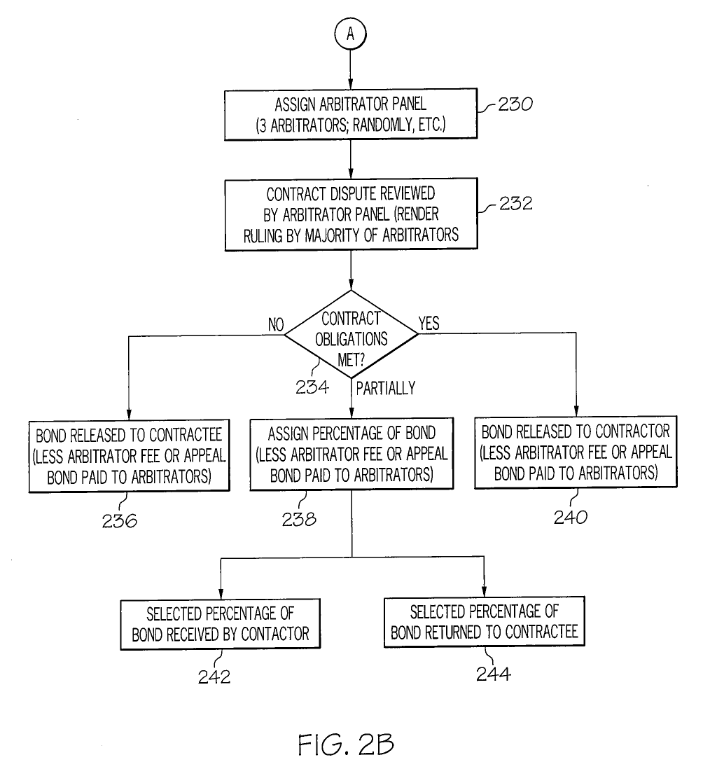

In accordance with an embodiment of the present invention, the virtual contract object 102 may additionally include an appeal module 132. The appeal module 132 provides a mechanism for appealing a decision in a contract dispute in the virtual world. For example, if the contractor, the contractee, or both do not accept the decision resulting from the dispute resolution process associated with dispute resolution module 130, the contractor, contractee, or both may appeal the decision or ruling as described herein. An example of a method that may be embodied in the appeal module 132 will be described in more detail with reference to FIGS. 2A and 2B. As described with reference to FIGS. 2A and 2B, an appeal bond 134 may be required from the party (contractor 116 or contractee 118 or both) that caused the appeal by rejecting the decision or ruling from the dispute resolution module 130 or process.

FIGS. 2A and 2B (collectively FIG. 2) are a flow chart of an example of a method 200 for appealing a decision in a contract dispute in a virtual world in accordance with an embodiment of the present invention. The method 200 may be embodied in the appeal module 132 of FIG. 1.

In block 202, a contract may be designated as being in dispute in response to a contractee rejecting fulfillment of the contract or for some other reason. In block 204, an arbitration process or dispute resolution process may be performed. A single arbitrator may be assigned. The single arbitrator may review the dispute and render a decision or ruling. The single arbitrator is also represented by an avatar, resident or otherwise an inhabitant of the virtual world. The arbitration or dispute resolution process may be similar to that described in U.S. patent application Ser. No. 11/861,837 which is incorporated herein by reference.

In block 206, a decision or ruling from the dispute resolution process or from the arbitrator may be presented to the contractor 208 and the contractee 210. The decision or ruling may be presented in a GUI and may include a mechanism to accept or reject the decision or ruling. For example, the GUI may include a pair of check boxes to select either accept or reject the decision of the arbitrator.

In block 212, a determination may be made whether the contractor 208 has approved or rejected the ruling or decision. Likewise, in block 214, a determination may be made whether the contractee 210 has approved or rejected the ruling or decision in the contract dispute from the arbitrator or other dispute resolution process. If both the contractor 208 and the contractee 210 approve or accept the ruling, the funds or bond associated with the contract may be dispersed according to the decision or ruling of the arbitrator in block 216.

If the contractor 208 rejects the decision, the method 200 may advance to block 218. Likewise, if the contractee 210 rejects the decision, the method 200 may advance to block 220. In either block 218 or block 220, the process to appeal the decision or ruling by the arbitrator may commence. In accordance with an embodiment of the present invention, a GUI may be presented to either the contractor 208 or to the contractee 210 or to both to enter any information related to the appeal. For example, the contractor 208 and contractee 210 may each enter an appeal brief statement for consideration by a panel of arbitrators in the appeal process. A contractor appeal brief statement 136 and a contractee appeal brief statement 138 may be stored in the virtual contract object 102 as illustrated in FIG. 1.

In accordance with another embodiment of the present invention, the party (contractor 208 or contractee 210) that initiated the appeal by rejecting the decision of the arbitrator or the party that first rejected the arbitrator's decision may be permitted to enter a statement of pertinent facts related to the contract dispute first and then the other party may be permitted to respond to the first parties statement of facts as illustrated by the broken line 222. The first party may be permitted to rebut the second party's response.

In accordance with an embodiment of the present invention, in either block 224 or block 226 or both, an appeal bond may be requested from the party that initiated or caused the appeal by rejecting the decision in the earlier dispute resolution process. A prorated appeal bond or equal portions of the appeal bond may be requested from the contractor 208 and contractee 210 if both parties are appealing the contract dispute decision or rejected the earlier dispute resolution decision. The appeal bond may be stored in a virtual contract object as illustrated by the appeal bond 134 in the virtual contract object 102 in FIG. 1. The appeal bond 134 may be used to at least partially compensate each of the arbitrators forming the panel of arbitrators that review and determine a resolution to the contract dispute. A portion of the appeal bond 134 may also be paid to the winning party or as part of the resolution to the contract dispute.

In accordance with an embodiment of the present invention, the contractor 116 and contractee 118 may be permitted to resolve the contract dispute prior to submitting the appeal bond. A predetermined GUI or GUIs may be presented to permit a dialogue between the contractor 116 and 118. For example, Internet communications technology, such as instant messaging, local chat or the like may be used to permit settlement or resolution of the dispute prior to payment or submission of the appeal bond.

In block 228, the virtual contract object, such as virtual contract object 102 in FIG. 1, may be updated to include all information associated with the appeal. The virtual contract object 102 may be updated in response to receipt of the appeal bond 134 from the party that initiated the appeal or from both parties as the case may be. As previously discussed, the virtual contract object 102 may include the appeal bond 134 and may store the appeal brief statements of the contractor 208 and contractee 210.

In block 230, a panel of arbitrators may be assigned to review the appeal and determine or select a resolution. Three arbitrators may form the panel. An arbitrator may be another user, avatar or resident of the virtual world that has agreed to serve as an arbitrator in reviewing contract disputes in the virtual world. The panel of arbitrators may be selected randomly from a list or pool of arbitrators or the panel of arbitrators may be assigned sequentially from the list for each subsequent appeal. A user may be invited by the virtual world system to become an arbitrator when the user logs on the system. A GUI or dialog box may be presented to the user in response to logging on which may ask the user if he would like to be an arbitrator. If the user responds affirmatively, the user will be added to the list or pool of arbitrators.

The virtual world system could advertise for arbitrators in other ways, but to more quickly get the arbitration feature and appeal feature operational, random users could be automatically invited to be arbitrators when they log on if there is not already a pool of arbitrators currently logged on in the virtual world. Users may be encouraged to be arbitrators by providing that arbitrators are paid a predetermined fee for each dispute they resolve or appeal on which they serve on the panel.

Arbitrators may be required to take instruction or a brief online class about the arbitration procedure and to electronically certify or promise to be fair in resolving disputes to the best of their ability. The virtual world system or virtual contract object 102 may track arbitrator fairness. One example of a scalable and automatic way to track fairness may be to track the percentage of dispute resolutions that are appealed.

Arbitrators may also be encouraged to be fair and to provide resolutions that make both parties “feel good” by paying a higher arbitration fee to those arbitrators that have a lower appeal percentage. The higher arbitration fee may be an extra fee over and above a normal, preset fee that may be paid from the bond. The extra fee may be absorbed or paid by the virtual world operator or entity that is sponsoring the virtual world system. The system operator has an interest in having fair arbitrators because this will encourage more users to participate in the system operator's virtual world.

Returning to FIG. 2, in block 232, the contract appeal may be reviewed by the panel of arbitrators. The appeal information may be presented to each of the arbitrators in a GUI. The arbitrators may each review the appeal brief statements and any other information related to the appeal.

In block 234, each of the arbitrators may determine the extent to which the contract terms or obligations may have been met or fulfilled. In accordance with an embodiment of the present invention, the appeal module 132 may include a mechanism to present a GUI to each arbitrator to review the contract dispute and the appeal information. A plurality of possible resolutions to the contract dispute may be presented to each of arbitrators to select one of the plurality of resolutions. A final decision or ruling in the contract dispute may be the one of the plurality of possible resolutions selected by the majority of arbitrators on the panel.

Examples of possible resolutions are that may be selected by each arbitrator are illustrated in blocks 236, 238, and 240. In block 236, an arbitrator may select to release the contract bond to the contractee if the arbitrator determines that the contract obligations have not been met in block 234. The contract bond is the bond 122 in FIG. 1 for payment in return for fulfillment or satisfaction of the contract by the contractor 116.

In block 238, each arbitrator may chose to assign a selected percentage of the contract bond to each of the parties if the arbitrator determines that the contract obligations have been partially met in block 234. The arbitrator may assign a selective percentage of the contract bond to be paid to each of the parties, as indicated in blocks 242 and 244.

In block 240, each arbitrator may chose to release the contract bond to the contractor if the arbitrator determines that the contract obligations have been met in block 234. In each possible resolution, blocks 236-240, the amount paid or released may be less the arbitrator fee or any portion of the appeal bond. The contract bond may have already been reduced by the arbitrator's fee in the arbitration process in block 204.

The panel of arbitrators may review the contract dispute and determine or select a resolution independently or jointly. As previously discussed, the final decision in the appeal or dispute resolution may be the resolution, blocks 236-240, selected by the majority of arbitrators on the panel.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method operable on a server for appealing a decision in a contract dispute in a virtual world, comprising:
receiving at the server a rejection of the decision in the contract dispute in the virtual world from at least one of a first personal computer associated with a contractor and a second personal computer associated with a contractee, wherein the decision in the contract dispute is made by a single arbitrator; and
providing a mechanism to appeal the decision by the single arbitrator in the contract dispute in response to receiving the rejection from at least one of the first personal computer associated with the contractor and the second personal computer associated with the contractee.

2. The method of claim 1, further comprising dispersing by the server any virtual funds in response to the contractor and the contractee both accepting the decision in the contract dispute.

3. The method of claim 1, further comprising receiving at the server from the contractor and the contractee appeal brief statement for consideration in deciding the appeal.

4. The method of claim 3, further comprising storing by the server any contractor appeal brief statement and any contractee appeal brief statement in a virtual contract object stored at the server.

5. The method of claim 1, further comprising requiring an appeal bond from at least one of the contractor and the contractee causing the appeal by the rejection of the decision in the contract dispute.

6. The method of claim 5, further comprising storing by the server the appeal bond in a virtual contract object stored at the server.

7. The method of claim 1, further comprising updating by the server a virtual contract object with information related to the appeal.

8. The method of claim 1, further comprising:
assigning at the server a panel of arbitrators to review the appeal; and
presenting by the server a GUI to each of the arbitrators to permit each of the arbitrators to review the contract dispute and any appeal brief statements.

9. The method of claim 8, wherein assigning the panel of arbitrators comprises assigning by the server a predetermined number of arbitrators by one of a random order and a predetermined order.

10. The method of claim 8, further comprising presenting by the server a plurality of possible resolutions of the contract dispute for each arbitrator to select, wherein a final decision in the contract dispute corresponds to any one of the plurality of possible resolutions being selected by a majority of the arbitrators.

11. The method of claim 10, wherein presenting the plurality of possible resolutions of the contract dispute comprises:
presenting by the server a first resolution that no contract terms have been fulfilled and a bond is releasable back to the contractee;
presenting by the server a second resolution that contract terms have been partially fulfilled and a first selected percentage of the bond is releasable to the contractor and a second selected percentage of the bond is returnable to the contractee; and
presenting by the server a third resolution that all contract terms have been fulfilled and the bond is releasable to the contractor.

12. A method operable on a server for appealing a decision in a contract dispute in a virtual world, comprising:
presenting by the server the decision in the contract dispute in the virtual world to a contractor and a contractee, wherein the decision in the contract dispute is made by a single arbitrator;
permitting by the server the contractor and the contractee to accept or reject the decision in the contract dispute;
presenting by the server a graphical user interface on a first personal computer associated with the contractor and a second personal computer associated with the contractee to allow initiation of an appeal the decision in the contract dispute;
assigning by the server a panel of arbitrators to review the appeal;
presenting by the server information related to the contract dispute to each of the arbitrators to permit each of the arbitrators to review the contract dispute and to determine a resolution; and
presenting by the server a decision in the appeal of the contract dispute to the contractor and the contractee.

13. The method of claim 12, further comprising permitting by the server the contractor and the contractee to send to the server an appeal brief statement for consideration by the panel of arbitrators in deciding the appeal.

14. The method of claim 12, further comprising:
obtaining by the server an appeal bond from which ever one of the contractor and the contractee initiated the appeal by rejecting the decision in the contract dispute by a single arbitrator; and
obtaining by the server the appeal bond prorated from each of the contractor and contractee in response to both the contractor and the contractee initiating the appeal by both rejecting the decision in the contract dispute by the single arbitrator.

15. The method of claim 14, further comprising:
updating a virtual contract object on the server with information related to the appeal; and
storing the appeal bond in the virtual contract object on the server.

16. The method of claim 14, further comprising permitting the contractor and contractee to resolve the contract dispute prior to submitting the appeal bond.

17. The method of claim 12, wherein assigning the panel of arbitrators comprises assigning three arbitrators to the panel, wherein the three arbitrators are assigned by one of randomly and by a predetermined order.

18. A method operable on a server for appealing a decision in a contract dispute in a virtual world, comprising:
presenting by the server the decision in the contract dispute in the virtual world to a first personal computer associated with a contractor and a second personal computer associated with a contractee, wherein the decision in the contract dispute is made by a single arbitrator;
receiving at the server a rejection of the decision in the contract dispute in the virtual world by at least one of the contractor and the contractee;
providing by the server a mechanism to appeal the decision in the contract dispute in response to receiving the rejection from at least one of the contractor and the contractee;
assigning by the server a panel of arbitrators to review the appeal;
presenting by the server information related to the contract dispute to each of the arbitrators to permit each of the arbitrators to review the contract dispute and to determine a resolution;
presenting by the server a plurality of possible resolutions of the contract dispute for each arbitrator to select, wherein a final decision in the contract dispute corresponds to any one of the plurality of possible resolutions being selected by a majority of the panel of arbitrators; and
presenting by the server the final decision to the contract dispute to the contractor and the contractee.

19. The method of claim 18, wherein providing a mechanism to appeal the decision in the contract dispute comprises presenting a graphical user interface by the server on the first personal computer associated with the contractor and on the second personal computer associated with a contractee to allow a selection to appeal the decision in the contract dispute.

20. The method of claim 18, wherein presenting the plurality of possible resolutions of the contract dispute comprises:
presenting by the server a first resolution that no contract terms have been fulfilled and a bond is releasable back to the contractee;
presenting by the server a second resolution that contract terms have been partially fulfilled and a first selected percentage of the bond is releasable to the contractor and a second selected percentage of the bond is returnable to the contractee; and
presenting by the server a third resolution that all contract terms have been fulfilled and the bond is releasable to the contractor.
